(19) United States
(12) Patent Application Publication
(10) Pub. No.: US 2025/0271628 A1
(43) Pub. Date: Aug. 28, 2025

(54) OPTICAL MODULE AND OPTICAL TRANSCEIVER

(71) Applicant: FUJITSU OPTICAL COMPONENTS LIMITED, Kawasaki-shi (JP)

(72) Inventors: Yamato IWAMA, Kawasaki (JP); Hirohiko SONODA, Sapporo (JP); Satoshi IDE, Yokohama (JP)

(73) Assignee: FUJITSU OPTICAL COMPONENTS LIMITED, Kawasaki-shi (JP)

(21) Appl. No.: 19/016,427

(22) Filed: Jan. 10, 2025

(30) Foreign Application Priority Data
Feb. 28, 2024 (JP) 2024-029194

(51) Int. Cl. G02B 6/42

(52) U.S. Cl. CPC G02B 6/4246; G02B 6/4257

(57) ABSTRACT

An optical module includes an optical transmitter that outputs transmission light to a transmission path port by using an optical signal, and an optical receiver that receives reception light received from the transmission path port by using the optical signal. The optical module includes an optical fiber that is a single mode optical fiber (SMF), that connects the optical transmitter and the optical receiver to the transmission path port, and through which the optical signal propagates. The wavelength of the optical signal is equal to or less than a cutoff wavelength of the optical fiber. The optical module incudes a holding mechanism that holds a bending shape of the optical fiber having a predetermined radius of curvature and through which only a basic mode included in the optical signal propagates.

### CROSS-REFERENCE TO RELATED APPLICATION

This application is based upon and claims the benefit of priority of the prior Japanese Patent Application No. 2024-029194, filed on Feb. 28, 2024, the entire contents of which are incorporated herein by reference.

### FIELD

The embodiments discussed herein are related to an optical module and an optical transceiver.

### BACKGROUND

For example, with the development of the Internet, in a large scale data center, an amount of data traffic continues to increase dramatically. In the future, introduction of the 5G mobile communication system advances, and, accordingly, progress of Artificial Intelligence (AI) and machine learning, implementation of a data-driven society that uses the Internet of Things (IoT) technology to which a huge number of sensors and terminals are connected, a self-driving technology, and the like are expected. Therefore, as the introduction of 5G progresses, the amount of data traffic is increasing at an accelerating rate.

In 5G, for example, about 100 antenna base stations used for 5G are present within a cell with a radius of 2 km. Furthermore, in 6G, a higher frequency of the radio frequency and a smaller size of the cell radius are anticipated. Accordingly, for example, in a case where a cell radius of an antenna base station used for 6G is 20 m, 10,000 antenna base stations to be used for 6G are needed within the cell with the radius of 2 km. In addition, in 6G, for example, high-speed communication with the data transfer rate of 1 terabyte per second or above that is further higher rate of 100 gigabits per second (bps).

Regarding the conventional 3G and 4G base stations, the base stations are installed in a building of telecommunications carriers or in the vicinity thereof, and these base stations and a network are connected. In contrast, regarding 5G and 6G base stations, introduction of optical fronthaul network using optical fibers starting from the 3G and 4G base stations or station buildings of the telecommunications carriers in which the base station has been installed advances.

Accordingly, in the future, there is a need to implement development of an optical module, such as an optical transceiver, provided with a single core bidirectional optical device that uses a single mode fiber with 100 Gbps class in a distance less than 10 km by 2030.

In the optical module, for example, in a case where an optical signal having a wavelength in a wavelength range of 1 μm is transmitted by using an optical fiber that is a single mode optical fiber (SMF) that supports a wavelength range of 1.3 μm, a higher-order mode is generated caused by reflection of the optical signal that propagates through a transmission path. As a result of this, the higher-order mode affects the basic mode, which is a factor that degrades transmission. Accordingly, in a case of long-distance transmission or high bit rate transmission, a mode filter is needed as a function for removing the higher-order mode. Furthermore, the SMF that supports the wavelength range of 1.3 μm mentioned above indicates the optical fiber capable of performing basic mode transmission of an optical signal in the wavelength range of 1.3 μm.

An example of the mode filter includes a higher-order mode filter constituted by using a technique in which an optical fiber is bent. There is a need to constitute a structure of the higher-order mode filter that holds the radius of curvature, with high accuracy, in which the basic mode is not emitted while the higher-order mode propagating a waveguide is emitted due to the optical fiber being bent.

In the higher-order mode filter constituted by using the technique in which the optical fiber is bent, in general, a probability of breakage of the optical fiber becomes high caused by the optical fiber being bent with a small curvature, so that there is a need to improve the bending strength of the optical fiber.

FIG. 17 is an explanation diagram illustrating one example of an optical module 100 that is conventionally used. The optical module 100 illustrated in FIG. 17 includes a substrate 101, a housing 102, an optical fiber 103, a transmission path port 105, and a mandrel 104. On the substrate 101, an optical transmitter 106 and an optical receiver 107 are mounted. The housing 102 is a housing that is used for the optical module 100 and that is used to mount the substrate 101 on the housing 102. The transmission path port 105 is an input/output port that connects the optical fiber 103 and a transmission path (not illustrated) that is provided an outside portion.

One end of the optical fiber 103 is connected to the optical transmitter 106 and the optical receiver 107 located on the substrate 101, and the other end of the optical fiber 103 is connected to the transmission path port 105. The mandrel 104 forms a bending shape by allowing the optical fiber 103 to be wrapped around the mandrel 104 and hold the formed bending shape. As a result of this, the bending shape of the optical fiber 103 wrapped around the mandrel 104 functions as a mode filter that removes the higher-order mode of an optical signal propagating through the optical fiber 103.

The optical module 100 is able to suppress transmission degradation of the optical signal by allowing only the basic mode to propagate by emitting the higher-order mode from the optical signal that propagates through the optical fiber 103 having the bending shape.
Patent Document 1: U.S. Patent Application Publication No. 2019/0115722
Patent Document 2: Japanese Laid-open Patent Publication No. 2021-189252
Patent Document 3: U.S. Pat. No. 10,191,221

However, in the optical module 100 that is conventionally used, the radius of curvature of the optical fiber 103 is not stable due to the stress of the optical fiber 103 itself that is wrapped around the mandrel 104, so that it is difficult to stably function as the mode filter.

Furthermore, in the optical module 100, it is conceivable that an optical axis misalignment is generated at an optical coupling portion that is connected to the optical fiber 103 due to the stress of the optical fiber 103 itself that is wrapped around the mandrel 104. Examples of the optical coupling portion include an optical coupling portion that is coupled to the transmission path port 105 that is connected to the other end of the optical fiber 103, an optical coupling portion that is coupled to each of the optical transmitter 106 and the optical receiver 107 that are connected to one end of the optical fiber 103.

In addition, in an optical module that is used in the future, it is conceivable to use a case in which a plurality of the optical fibers 103 are arranged in an array (arranged in parallel), but the influence of the stress of the optical fibers 103 tends to further increase, and thus, it is also conceivable that the optical axis misalignment in the optical coupling portion further increases.

In addition, in an optical module that is used in the future, packaging density of the parts accordingly increases, so that the size of the module main body increases due to the need to ensure the installation area of the mandrel 104.

Accordingly, in the future, an optical module capable of contributing to a reduction in the size of the module main body while ensuring a stable mode filter function is needed.

### SUMMARY

According to an aspect of an embodiment, an optical module includes an optical transmitter, an optical receiver and an optical fiber. The optical transmitter outputs transmission light to a transmission path port by using an optical signal. The optical receiver receives reception light received from the transmission path port by using the optical signal. The optical fiber is a single mode optical fiber (SMF) and connects the optical transmitter and the optical receiver to the transmission path port. The optical signal propagates through the optical fiber. a wavelength of the optical signal is equal to or less than a cutoff wavelength of the optical fiber. The optical module includes a holding mechanism that holds a bending shape of the optical fiber that has a predetermined radius of curvature and through which only a basic mode included in the optical signal propagates.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanation diagram illustrating one example of an optical module according to a first embodiment;

FIG. 2 is an explanation diagram illustrating one example of an optical module according to a second embodiment;

FIG. 3 is an explanation diagram illustrating one example of a holding mechanism of an optical module according to a third embodiment;

FIG. 4 is an explanation diagram illustrating one example of a holding mechanism of an optical module according to a fourth embodiment;

FIG. 5 is an explanation diagram illustrating one example of a holding mechanism of an optical module according to a fifth embodiment;

FIG. 6 is an explanation diagram illustrating one example of a holding mechanism of an optical module according to a sixth embodiment;

FIG. 7 is an explanation diagram illustrating one example of an optical module according to a seventh embodiment;

FIG. 8 is an explanation diagram illustrating one example of an optical module according to an eighth embodiment;

FIG. 9 is an explanation diagram illustrating one example of an optical module according to a ninth embodiment;

FIG. 10 is an explanation diagram illustrating one example of an optical module according to a tenth embodiment;

FIG. 11 is an explanation diagram illustrating one example of an optical module according to an eleventh embodiment;

FIG. 12 is an explanation diagram illustrating one example of a cross-sectional view taken along line A-A illustrated in FIG. 11;

FIG. 13 is an explanation diagram illustrating one example of an optical module according to a twelfth embodiment;

FIG. 14 is an explanation diagram illustrating one example of a cross-sectional view taken along line B-B illustrated in FIG. 13;

FIG. 15 is an explanation diagram illustrating one example of an optical module according to a thirteenth embodiment;

FIG. 16 is an explanation diagram illustrating one example of an optical transceiver according to the present embodiment; and

FIG. 17 is an explanation diagram illustrating one example of an optical module according to a conventional optical module.

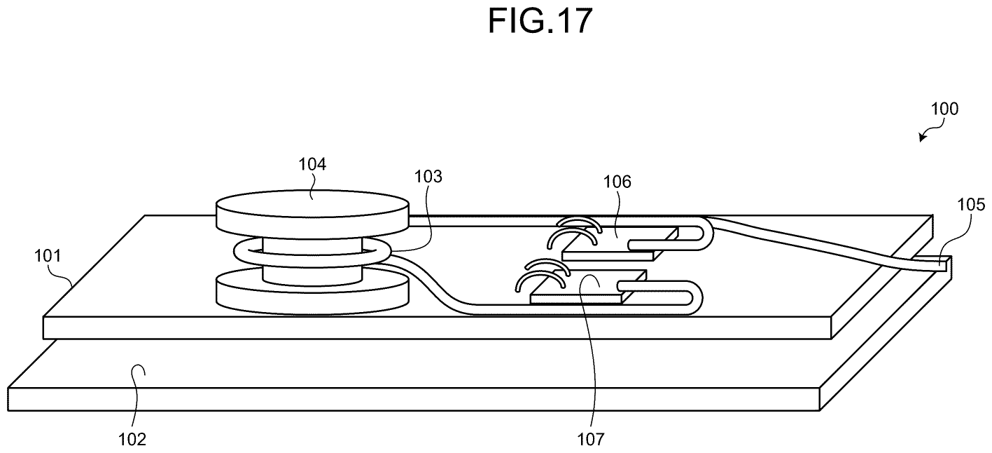

### DESCRIPTION OF EMBODIMENTS

Preferred embodiments of the present invention will be explained with reference to accompanying drawings. Furthermore, the present invention is not limited to the embodiments. In addition, each of the embodiments can be used in any appropriate combination as long as they do not conflict with each other.
(a) First Embodiment

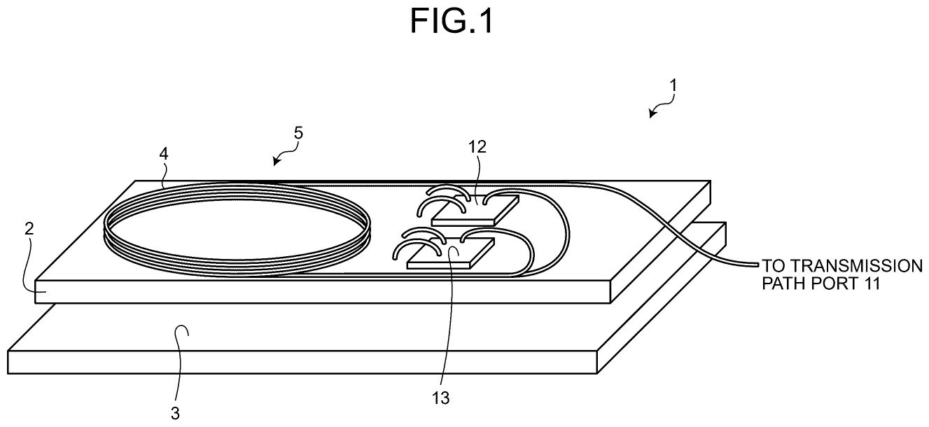

FIG. 1 is an explanation diagram illustrating one example of an optical module 1 according to a first embodiment. The optical module 1 illustrated in FIG. 1 is, for example, a single core bidirectional optical device. The optical module 1 includes a substrate 2, a housing 3, an optical fiber 4, a holding mechanism 5, and a transmission path port 11. On the substrate 2, an optical transmitter 12 and an optical receiver 13 are packaged. The optical transmitter 12 is, for example, an optical device, such as an optical modulator or a light emission element, that modulates an optical signal received from a light emission element to transmission light on the basis of an electrical signal according to transmission data, and that outputs the modulated transmission light to the transmission path port 11 via the optical fiber 4. The optical transmitter 12 is, for example, a vertical cavity surface emitting laser (VCSEL) transmitter. Furthermore, the optical transmitter 12 generally uses signal light in a wavelength range of 857 nm, but the optical transmitter 12 may also use transmission light in a wavelength range of 1 μm.

The optical receiver 13 is, for example, an optical device, such as an optical hybrid circuit or light reception element, that receives reception light sent from the transmission path port 11 by using the optical signal, and that obtains an electrical signal according to reception data obtained from the received reception light. The housing 3 is a housing for optical module 1 in order to mount the substrate 2 on the housing 3. The transmission path port 11 is an input/output port that connects the optical fiber 4 and a transmission path (not illustrated) that is provided in an outside portion.

One end of the optical fiber 4 is connected to the optical transmitter 12 and the optical receiver 13 that are mounted on the substrate 2, and the other end of the optical fiber 4 is connected to the transmission path port 11. Furthermore, the optical fiber 4 is an optical fiber with a type of, for example, a single mode fiber (SMF) that connects the optical transmitter 12 and the optical receiver 13 to the transmission path port 11, and through which the optical signal propagates. The optical signal uses a wavelength in a wavelength range equal to or less than 1.26 μm that is a cutoff wavelength of the optical fiber with the type of SMF that supports a wavelength in a wavelength range of, for example, 1.3 μm.

The optical fiber 4 is a mode filtering fiber that is arranged in a bending shape having a predetermined radius of curvature and that allows for fulfillment of a mode filter function for removing a higher-order mode signal that is included in the propagating optical signal as a result of the higher-order mode being emitted and propagating only the basic mode other than the higher-order mode.

In addition, the holding mechanism 5 is a mechanism that is mounted on the substrate 2, and that holds the bending shape of the optical fiber 4 having the predetermined radius of curvature. Furthermore, the optical fiber 4 is held in the form of the bending shape having the predetermined radius of curvature by the holding mechanism 5, so that only the basic mode included in the optical signal propagating through each of a portion between the optical transmitter 12 and the transmission path port 11 and a portion between the optical receiver 13 and the transmission path port 11 propagates.

The holding mechanism 5 holds the bending shape of the optical fiber 4 having the predetermined radius of curvature, so that it is possible to suppress an optical axis misalignment at an optical coupling portion in which the optical transmitter 12 and the optical receiver 13 are connected to one end of the optical fiber 4 and an optical coupling portion in which the transmission path port 11 that is connected to the other end of the optical fiber 4.

In the optical module 1 according to the first embodiment, the holding mechanism 5 that holds the bending shape of the optical fiber 4 having the predetermined radius of curvature and that is able to fulfill the mode filter function is provided on the substrate 2. As a result of this, regarding the holding mechanism 5, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4 is held by the holding mechanism 5, so that it is possible to suppress a rupture probability and an optical axis misalignment of the optical fiber 4 while suppressing the stress of the optical fiber 4 itself.

Moreover, in the optical module 1 according to the first embodiment, the case has been described as an example in which the holding mechanism 5 is mounted on the substrate 2, but the embodiment is not limited to this. The holding mechanism 5 may be mounted on the housing 3, and an embodiment thereof will be described below as a second embodiment.
(b) Second Embodiment

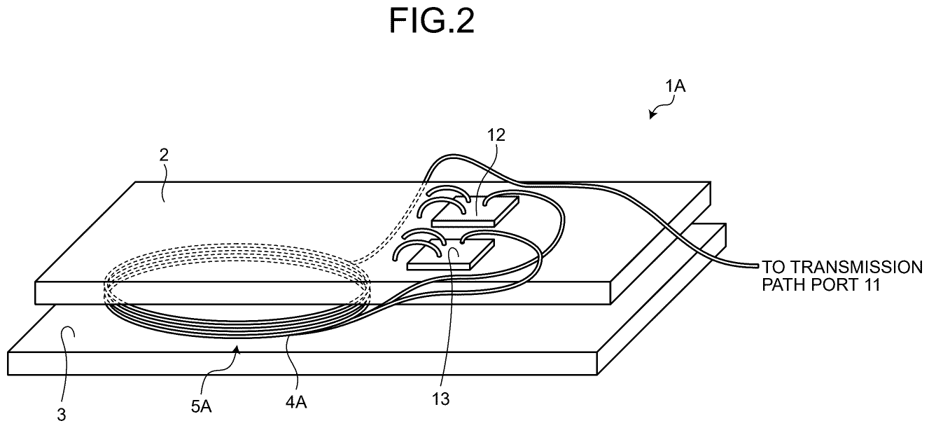

FIG. 2 is an explanation diagram illustrating one example of an optical module 1A according to the second embodiment. Furthermore, by assigning the same reference numerals to components having the same configuration as those in the optical module 1 according to the first embodiment, overlapped descriptions of the configuration and the operation thereof will be omitted. The optical module 1A according to the second embodiment is different from the optical module 1 according to the first embodiment in that a holding mechanism 5A that holds the bending shape of an optical fiber 4A having the predetermined radius of curvature is mounted on the housing 3.

The holding mechanism 5A is mounted on the housing 3, holds the bending shape of the optical fiber 4A having the predetermined radius of curvature, and that is able to fulfill the mode filter function. Furthermore, the bending shape of the optical fiber 4A having the predetermined radius of curvature is held by the holding mechanism 5A, so that only the basic mode included in the optical signals propagating through a portion between the optical transmitter 12 and the transmission path port 11 and a portion between the optical receiver 13 and the transmission path port 11 propagates.

The holding mechanism 5A holds the bending shape of the optical fiber 4A having the predetermined radius of curvature. As a result of this, the holding mechanism 5A suppresses an optical axis misalignment at an optical coupling portion in which the optical transmitter 12 and the optical receiver 13 are connected to one end of the optical fiber 4A and an optical coupling portion in which the transmission path port 11 that is connected to the other end of the optical fiber 4A.

In the optical module 1A according to the second embodiment, the holding mechanism 5A that holds the bending shape of the optical fiber 4A having the predetermined radius of curvature and that is able to fulfill the mode filter function is provided on the housing 3. As a result of this, regarding the holding mechanism 5A, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4A is held by the holding mechanism 5A, so that it is possible to suppress a rupture probability and an optical axis misalignment of the optical fiber 4A while suppressing the stress of the optical fiber 4A itself.

Moreover, in the optical module 1 according to the first embodiment, the case has been described as an example in which the holding mechanism 5 is mounted on the substrate 2, and an embodiment of one example thereof will be described below as a third embodiment.
(c) Third Embodiment

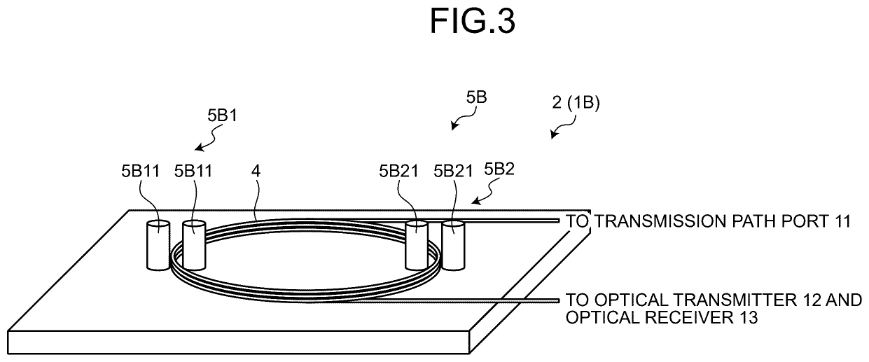

FIG. 3 is an explanation diagram illustrating one example of a holding mechanism 5B included in an optical module 1B according to the third embodiment. Furthermore, by assigning the same reference numerals to components having the same configuration as those in the optical module 1 according to the first embodiment, overlapped descriptions of the configuration and the operation thereof will be omitted. FIG. 3 illustrates the relevant part of the holding mechanism 5B mounted on the substrate 2, and illustrations of the optical transmitter 12, the optical receiver 13, the housing 3, and the like are omitted. The holding mechanism 5B illustrated in FIG. 3 is mounted on the substrate 2, and includes a first holding unit 5B1 that is arranged on the one end side of the top surface of the substrate 2 and a second holding unit 5B2 that is arranged on the other end side of the top surface of the substrate 2.

The first holding unit 5B1 includes two first columnar supports 5B11, and holds one end of the optical fiber 4. The first holding unit 5B1 holds the outer circumference and the inner circumference of one end of the optical fiber 4 by allowing a part of the optical fiber 4 to be routed and sandwiched between the two first columnar supports 5B11.

The second holding unit 5B2 includes two second columnar supports 5B21, and holds the other end of the optical fiber 4. The second holding unit 5B2 holds the outer circumference and the inner circumference of the other end of the optical fiber 4 by allowing a part of the optical fiber 4 to be routed and sandwiched between the two second columnar supports 5B21.

Then, the holding mechanism 5B holds one end of the optical fiber 4 between the two first columnar supports 5B11 included in the first holding unit 5B1, and holds the other end of the optical fiber 4 between the two second columnar supports 5B21 included in the second holding unit 5B2. As a result of this, the holding mechanism 5B forms a bending shape of the optical fiber 4 having a predetermined radius of curvature.

In other words, both of the two first columnar supports 5B11 included in the first holding unit 5B1 and the two second columnar supports 5B21 included in the second holding unit 5B2 are accordingly arranged at a position of the top surface of the substrate 2 in which the optical fiber 4 is able to be formed in the shape having the predetermined radius of curvature and held its shape.

The holding mechanism 5B included in the optical module 1B according to the third embodiment holds the one end of the optical fiber 4 from the inner diameter and the outer diameter by allowing the one end of the optical fiber 4 to be routed and sandwiched between the two first columnar supports 5B11 that are included in the first holding unit 5B1 and that are arranged on the one end side of the substrate 2. The holding mechanism 5B holds the other end of the optical fiber 4 from the inner diameter and the outer diameter by allowing the other end of the optical fiber 4 to be routed and sandwiched between the two second columnar supports 5B21 that are included in the second holding unit 5B2 and that are arranged on the other end side of the substrate 2. Then, the holding mechanism 5B forms the bending shape of the optical fiber 4 by the first holding unit 5B1 and the second holding unit 5B2, and holds the formed shape of the optical fiber 4. As a result of this, regarding the holding mechanism 5B, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4 is held by the holding mechanism 5B, so that it is possible to suppress a rupture probability and an optical axis misalignment of the optical fiber 4 while suppressing the stress of the optical fiber 4 itself.

Moreover, regarding the optical module 1 according to the first embodiment, the case has been described as an example in which the holding mechanism 5A is mounted on the housing 3, and an embodiment of one example thereof will be described below as a fourth embodiment.
(d) Fourth Embodiment

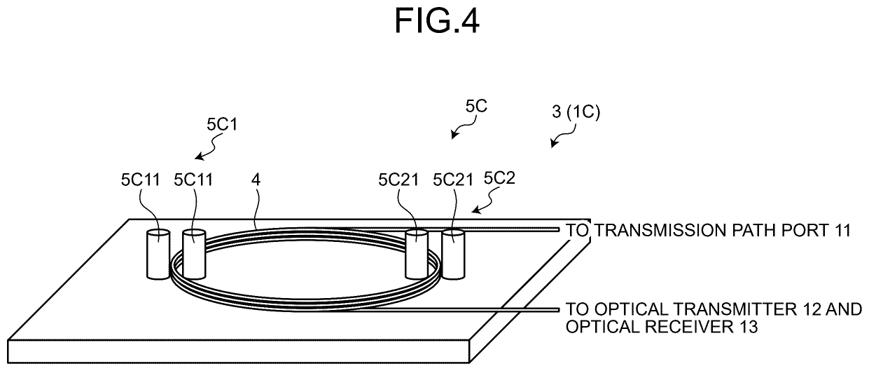

FIG. 4 is an explanation diagram illustrating one example of a holding mechanism 5C included in an optical module 1C according to the fourth embodiment. Furthermore, by assigning the same reference numerals to components having the same configuration as those in the optical module 1A according to the second embodiment, overlapped descriptions of the configuration and the operation thereof will be omitted. FIG. 4 illustrates the relevant part of the holding mechanism 5C mounted on the housing 3, and illustrations of the substrate 2 on which the optical transmitter 12 and the optical receiver 13 are packaged are omitted. The holding mechanism 5C illustrated in FIG. 4 is mounted on the housing 3, and includes a first holding unit 5C1 that is arranged on the one end side of the top surface of the housing 3 and a second holding unit 5C2 that is arranged on the other end side of the top surface of the housing 3.

The first holding unit 5C1 includes two first columnar supports 5C11, and holds the one end of the optical fiber 4A. The first holding unit 5C1 holds the outer circumference and the inner circumference of the one end of the optical fiber 4A by allowing a part of the optical fiber 4A to be routed and sandwiched between the two first columnar supports 5C11.

The second holding unit 5C2 includes two second columnar supports 5C21, and holds the other end of the optical fiber 4A. The second holding unit 5C2 holds the outer circumference and the inner circumference of the other end of the optical fiber 4A by allowing a part of the optical fiber 4A to be routed and be sandwiched between the two second columnar supports 5C21.

Then, the holding mechanism 5C holds the one end of the optical fiber 4A between the two first columnar supports 5C11 included in the first holding unit 5C1, and holds the other end of the optical fiber 4A between the two second columnar supports 5C21 included in the second holding unit 5C2. As a result of this, the holding mechanism 5C forms a bending shape of the optical fiber 4A having a predetermined radius of curvature and holds the formed shape of the optical fiber 4A.

In other words, the two first columnar supports 5C11 included in the first holding unit 5C1 and the two second columnar supports 5C21 included in the second holding unit 5C2 are accordingly arranged at a position of the top surface of the housing 3 in which the optical fiber 4A is able to be formed in the shape having the predetermined radius of curvature shape and held its shape.

The holding mechanism 5C included in the optical module 1C according to the fourth embodiment holds the one end of the optical fiber 4A from the inner diameter and the outer diameter by allowing the one end of the optical fiber 4A to be routed and sandwiched between the two first columnar supports 5C11 that are included in the first holding unit 5C1 and that are arranged on the one end side of the housing 3. The holding mechanism 5C holds the other end of the optical fiber 4A from the inner diameter and the outer diameter by allowing the other end of the optical fiber 4A to be routed and sandwiched between the two second columnar supports 5C21 that are included in the second holding unit 5C2 and that are arranged on the other end side of the housing 3. Then, the holding mechanism 5C forms the bending shape of the optical fiber 4A by the first holding unit 5C1 and the second holding unit 5C2, and holds the formed shape of the optical fiber 4A. As a result of this, regarding the holding mechanism 5C, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4A is held by the holding mechanism 5C, so that it is possible to suppress a rupture probability and an optical axis misalignment of the optical fiber 4A while suppressing the stress of the optical fiber 4A itself.

Moreover, regarding the optical module 1 according to the first embodiment, the case has been described as an example in which the holding mechanism 5 is mounted on the substrate 2, and an embodiment of one example thereof will be described below as a fifth embodiment.
(e) Fifth Embodiment

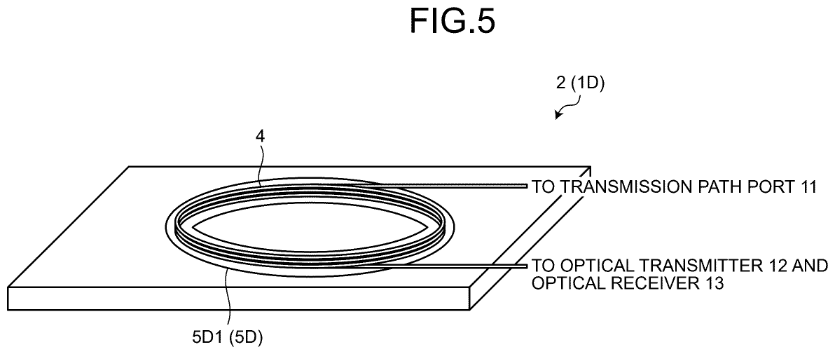

FIG. 5 is an explanation diagram illustrating one example of a holding mechanism 5D included in an optical module 1D according to the fifth embodiment. Furthermore, by assigning the same reference numerals to components having the same configuration as those in the optical module 1 according to the first embodiment, overlapped descriptions of the configuration and the operation thereof will be omitted. FIG. 5 illustrates the relevant part of the holding mechanism 5D mounted on the substrate 2, and illustrations of the optical transmitter 12, the optical receiver 13, the housing 3, and the like are omitted. The holding mechanism 5D illustrated in FIG. 5 includes a holding groove 5D1 that holds the optical fiber 4 and that is provided by carving the top surface of the substrate 2 and placing the holding mechanism 5D. The holding mechanism 5D forms the bending shape of the optical fiber 4 having a predetermined radius of curvature and holds the shaped form by allowing the optical fiber 4 to be routed in the interior of the holding groove 5D1. The holding groove 5D1 holds the entirety of the optical fiber 4 from the inner diameter and the outer diameter of the optical fiber 4.

In other words, the holding groove 5D1 is formed on the top surface of the substrate 2 with the size and the shape that are enough for the optical fiber 4 to be formed in the shape of the predetermined radius of curvature and held in the formed shape.

The holding mechanism 5D included in the optical module 1D according to the fifth embodiment forms the bending shape of the optical fiber 4 having the predetermined radius of curvature capable for the holding mechanism 5D such that the holding mechanism 5D is able to fulfill the mode filter function, and holds the formed bending shape of the optical fiber 4 by allowing the optical fiber 4 to be routed in the interior of the holding groove 5D1 that is provided on the top surface of the substrate 2. As a result of this, regarding the holding mechanism 5D, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4 is held by the holding mechanism 5D, so that it is possible to suppress a rupture probability and an optical axis misalignment of the optical fiber 4 while suppressing the stress of the optical fiber 4 itself.

Moreover, regarding the optical module 1A according to the second embodiment, the case has been described as an example in which the holding mechanism 5A is mounted on the housing 3, and an embodiment of one example thereof will be described below as a sixth embodiment.
(f) Sixth Embodiment

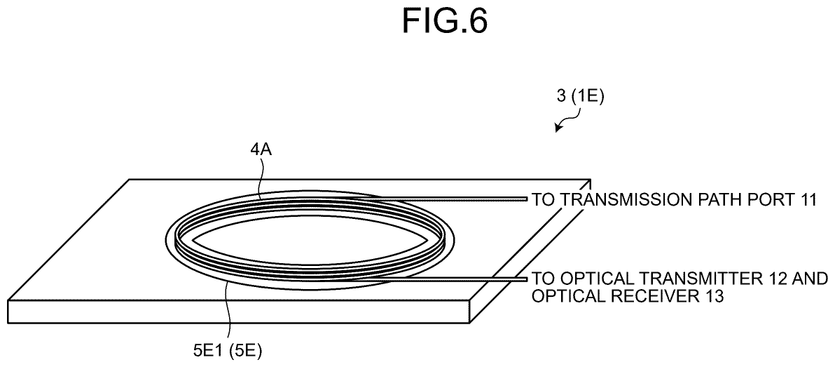

FIG. 6 is an explanation diagram illustrating one example of a holding mechanism 5E included in an optical module 1E according to the sixth embodiment. Furthermore, by assigning the same reference numerals to components having the same configuration as those in the optical module 1A according to the second embodiment, overlapped descriptions of the configuration and the operation thereof will be omitted. FIG. 6 illustrates the relevant part of the holding mechanism 5E provided on the housing 3, and illustrations of the substrate 2 on which the optical transmitter 12 and the optical receiver 13 are packaged, and the like are omitted. The holding mechanism 5E illustrated in FIG. 6 includes a holding groove 5E1 that holds the optical fiber 4A and that is provided by carving the top surface of the housing 3. The holding mechanism 5E forms the bending shape of the optical fiber 4A having the predetermined radius of curvature and holds the formed shape by allowing the optical fiber 4A to be routed in the interior of the holding groove 5E1. The holding groove 5E1 holds the entirety of the optical fiber 4A from the inner diameter and the outer diameter of the optical fiber 4A.

In other words, the holding groove 5E1 is formed on the top surface of the housing 3 with the size and the shape that are enough for the optical fiber 4A to be formed in the shape of the predetermined radius of curvature and held in the formed shape.

The holding mechanism 5E included in the optical module 1E according to the sixth embodiment forms the bending shape of the optical fiber 4A having the predetermined radius of curvature such that the holding mechanism 5E is able to fulfill the mode filter function, and holds the bending shape of the optical fiber 4A by allowing the optical fiber 4A to be routed in the interior of the holding groove 5E1 that is provided on the top surface of the housing 3. As a result of this, regarding the holding mechanism 5E, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4A is held by the holding mechanism 5E, so that it is possible to suppress a rupture probability and an optical axis misalignment of the optical fiber 4A while suppressing the stress of the optical fiber 4A itself.

Moreover, regarding the optical module 1 according to the first embodiment, the case has been described as an example in which the holding mechanism 5 that holds the bending shape of the optical fiber 4 having the predetermined radius of curvature is provided on the substrate 2, but the bending shape of the optical fiber 4 may be formed as a preform, and appropriate modifications are possible. Accordingly, an embodiment in which the bending shape of the optical fiber 4 is formed as a preform will be described as a seventh embodiment.
(g) Seventh Embodiment

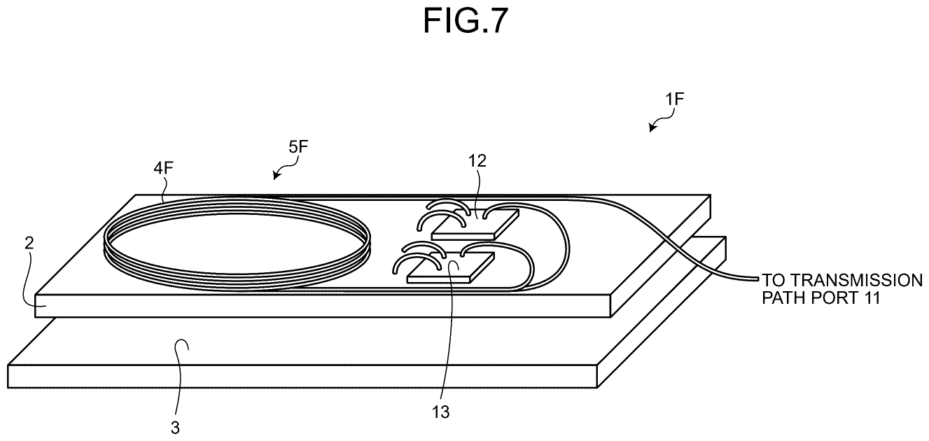

FIG. 7 is an explanation diagram illustrating one example of an optical module 1F according to the seventh embodiment. Furthermore, for convenience of description, by assigning the same reference numerals to components having the same configuration as those in the optical module 1 according to the first embodiment, overlapped descriptions of the configuration and the operation thereof will be omitted. The optical module 1F according to the seventh embodiment is different from the optical module 1 according to the first embodiment in that an optical fiber 4F that has been preformed in the bending shape having the predetermined radius of curvature by using stress relaxation by heat is used as a holding mechanism 5F.

The optical fiber 4F is an optical fiber that has a bending shape having a predetermined radius of curvature as a result of the stress of the optical fiber 4F itself being alleviated by performing heat treatment. The holding mechanism 5F is constituted by the optical fiber 4F that has been preformed in the bending shape having the predetermined radius of curvature, and the optical fiber 4F is fixed to the substrate 2 by an adhesive agent in the form remaining in the bending shape of the optical fiber 4F having the predetermined radius of curvature.

The optical module 1F according to the seventh embodiment holds the bending shape of the optical fiber 4F having the predetermined radius of curvature such that the optical module 1F is able to fulfill the mode filter function as a result of the stress of the optical fiber 4F itself being alleviated due to heat treatment. As a result of this, regarding the optical fiber 4F, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4F whose stress has been alleviated by the heat treatment is used, so that it is possible to suppress a rupture probability and an optical axis misalignment of the optical fiber 4F while suppressing the stress of the optical fiber 4F itself.

Moreover, regarding the optical module 1 according to the first embodiment, the case has been described as an example in which the holding mechanism 5 is mounted on the substrate 2, and an embodiment of one example thereof will be described below as an eighth embodiment.
(h) Eighth Embodiment

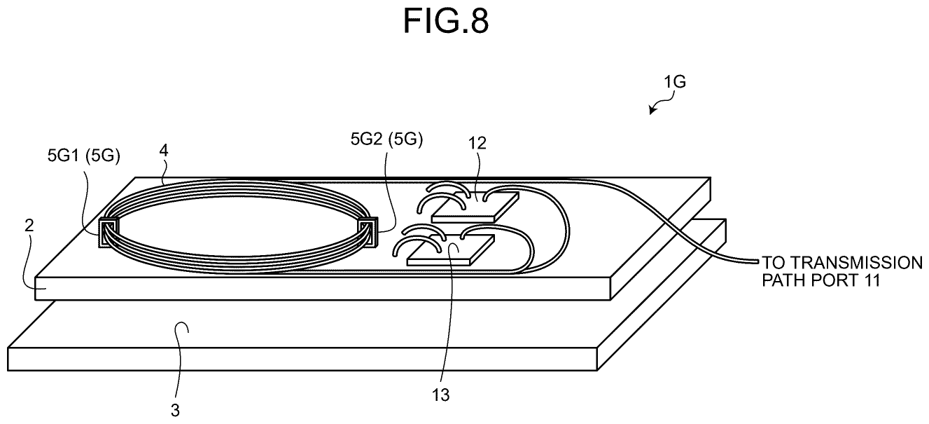

FIG. 8 is an explanation diagram illustrating one example of an optical module 1G according to the eighth embodiment. Furthermore, by assigning the same reference numerals to components having the same configuration as those in the optical module 1 according to the first embodiment, overlapped descriptions of the configuration and the operation thereof will be omitted. A holding mechanism 5G illustrated in FIG. 8 is mounted on the substrate 2, and includes a first holding unit 5G1 that is formed in a frame shape and that is arranged on the one end side of the top surface of the substrate 2 and a second holding unit 5G2 that is formed in a frame shape and that is arranged on the other end side of the top surface of the substrate 2.

The first holding unit 5G1 holds the outer circumference and the inner circumference of the one end of the optical fiber 4 having the predetermined radius of curvature. The second holding unit 5G2 holds the outer circumference and the inner circumference of the other end of the optical fiber 4 having the predetermined radius of curvature. Furthermore, the holding mechanism 5G uses the first holding unit 5G1 and the second holding unit 5G2, and holds the bending shape of the optical fiber 4 having the predetermined radius of curvature on the top surface of the substrate 2.

In other words, both of the first holding unit 5G1 and the second holding unit 5G2 are accordingly arranged at a position of the top surface of the substrate 2 in which the optical fiber 4 is able to be held in the bending shape having the predetermined radius of curvature.

The holding mechanism 5G included in the optical module 1G according to the eighth embodiment holds the one end of the optical fiber 4 from the inner diameter and the outer diameter of the optical fiber 4 by the first holding unit 5G1 that is arranged on the one end side of the substrate 2. The holding mechanism 5G holds the other end of the optical fiber 4 from the inner diameter and the outer diameter of the optical fiber 4 by the second holding unit 5G2 that is arranged on the other end side of the substrate 2. Furthermore, the holding mechanism 5G uses the first holding unit 5G1 and the second holding unit 5G2, and holds the bending shape of the optical fiber 4 having the predetermined radius of curvature such that the holding mechanism 5G is able to fulfill the mode filter function. As a result of this, regarding the holding mechanism 5G, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4 is held by the holding mechanism 5G, so that it is possible to suppress a rupture probability and an optical axis misalignment of the optical fiber 4 while suppressing the stress of the optical fiber 4 itself.

Moreover, regarding the optical module 1A according to the second embodiment, the case has been described as an example in which the holding mechanism 5A is mounted on the housing 3, and an embodiment of one example thereof will be described below as a ninth embodiment.
(i) Ninth Embodiment

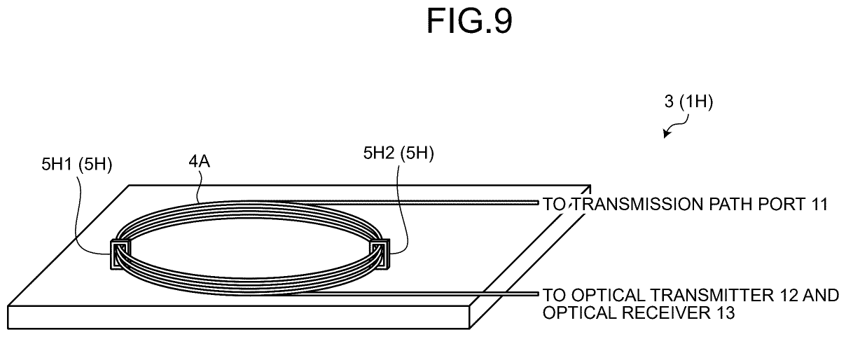

FIG. 9 is an explanation diagram illustrating one example of an optical module 1H according to the ninth embodiment. Furthermore, by assigning the same reference numerals to components having the same configuration as those in the optical module 1A according to the second embodiment, overlapped descriptions of the configuration and the operation thereof will be omitted. FIG. 9 illustrates the relevant part of a holding mechanism 5H provided on the housing 3, and illustrations of the substrate 2 on which the optical transmitter 12 and the optical receiver 13 are packaged, and the like are omitted. The holding mechanism 5H illustrated in FIG. 9 is mounted on the housing 3, and includes a first holding unit 5H1 that has a frame shape and that is arranged on the one end side of the top surface of the housing 3 and a second holding unit 5H2 that has a frame shape and that is arranged on the other end side of the top surface of the housing 3.

The first holding unit 5H1 holds the outer circumference and the inner circumference of the one end of the optical fiber 4A having a predetermined radius of curvature. The second holding unit 5H2 holds the outer circumference and the inner circumference of the other end of the optical fiber 4A having the predetermined radius of curvature. Furthermore, the holding mechanism 5H uses the first holding unit 5H1 and the second holding unit 5H2, and holds the bending shape of the optical fiber 4A having the predetermined radius of curvature on the top surface of the housing 3.

In other words, both of the first holding unit 5H1 and the second holding unit 5H2 are accordingly arranged at a position of the top surface of the housing 3 in which the optical fiber 4A is able to be held in the bending shape having the predetermined radius of curvature.

The holding mechanism 5H included in the optical module 1H according to the ninth embodiment holds the one end of the optical fiber 4A from the inner diameter and the outer diameter of the optical fiber 4A by the first holding unit 5H1 that is arrange on the one end side of the housing 3. The holding mechanism 5H holds the other end of the optical fiber 4A from the inner diameter and the outer diameter of the optical fiber 4A by the second holding unit 5H2 that is arranged on the other end side of the housing 3. Furthermore, the holding mechanism 5H uses the optical fiber 4A located at the first holding unit 5H1 and the second holding unit 5H2, and holds the bending shape of the optical fiber 4A having the predetermined radius of curvature such that the holding mechanism 5H is able to fulfill the mode filter function. As a result of this, the bending shape of the optical fiber 4A is being held, so that it is possible to ensure the stable mode filter function and eliminate the mandrel that is conventionally used, and, consequently, it is possible to implement a reduction in the size of the module main body. In addition, the optical fiber 4A is held by the holding mechanism 5H, so that it is possible to suppress a rupture probability and an optical axis misalignment of the optical fiber 4A while suppressing the stress of the optical fiber 4A itself.

Moreover, regarding the optical module 1 according to the first embodiment, the case has been described as an example in which the holding mechanism 5 is mounted on the substrate 2, and an embodiment of one example thereof will be described below as a ninth embodiment.
(j) Tenth Embodiment

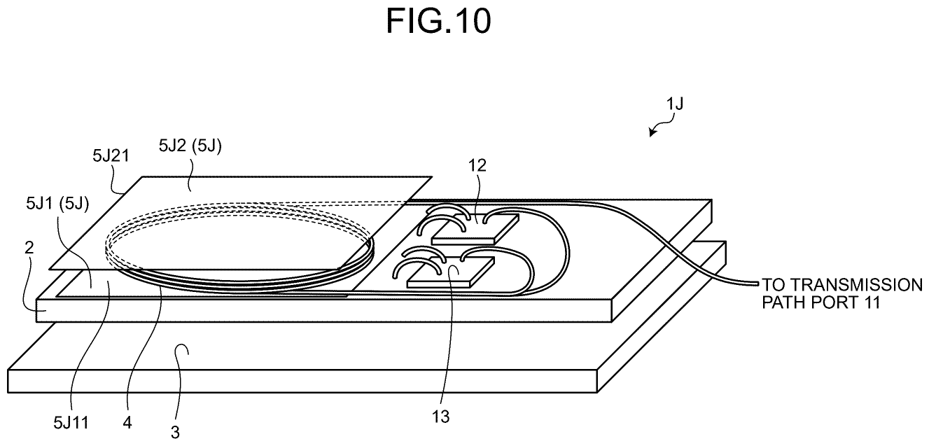

FIG. 10 is an explanation diagram illustrating one example of an optical module 1J according to the tenth embodiment. Furthermore, by assigning the same reference numerals to components having the same configuration as those in the optical module 1 according to the first embodiment, overlapped descriptions of the configuration and the operation thereof will be omitted. A holding mechanism 5J according to the tenth embodiment is different from the holding mechanism 5 according to the first embodiment in that the optical fiber 4 is held by two planes that are arranged on the upper side and the lower side of the optical fiber 4. The holding mechanism 5J includes a first structure unit 5J1 that has a first plane 5J11 and that abuts the optical fiber 4 from a plane direction of the optical fiber 4, and a second structure unit 5J2 that abuts the optical fiber 4 from a plane direction of the optical fiber 4 and that has a second plane 5J21 that is disposed opposite the first plane 5J11. The holding mechanism 5J holds the bending shape of the optical fiber 4 having the predetermined radius of curvature by sandwiching the optical fiber 4 by the first plane 5J11 and the second plane 5J21 from the plane directions.

The first structure unit 5J1 is mounted on the top surface of the substrate 2. Furthermore, the optical fiber 4 having the predetermined radius of curvature is placed on the first plane 5J11 of the first structure unit 5J1. Moreover, the optical fiber 4 is covered by the second plane 5J21 included in the second structure unit 5J2 from the plane direction. As a result of this, the holding mechanism 5J holds the bending shape of the optical fiber 4 having the predetermined radius of curvature by sandwiching the optical fiber 4 by the first plane 5J11 and the second plane 5J21 from the plane direction.

The holding mechanism 5J included in the optical module 1J according to the tenth embodiment holds the bending shape of the optical fiber 4 having the predetermined radius of curvature by sandwiching the optical fiber 4 by the first plane 5J11 and the second plane 5J21 from the plane direction. As a result of this, regarding the holding mechanism 5J, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber 4 is held by the holding mechanism 5J, so that it is possible to suppress a rupture probability and an optical axis misalignment of the optical fiber 4 while suppressing the stress of the optical fiber 4 itself.

Moreover, regarding the optical module 1 according to the first embodiment, the case has been described as an example in which the holding mechanism 5 is mounted on the substrate 2, and an embodiment of one example thereof will be described below as an eleventh embodiment.
(k) Eleventh Embodiment

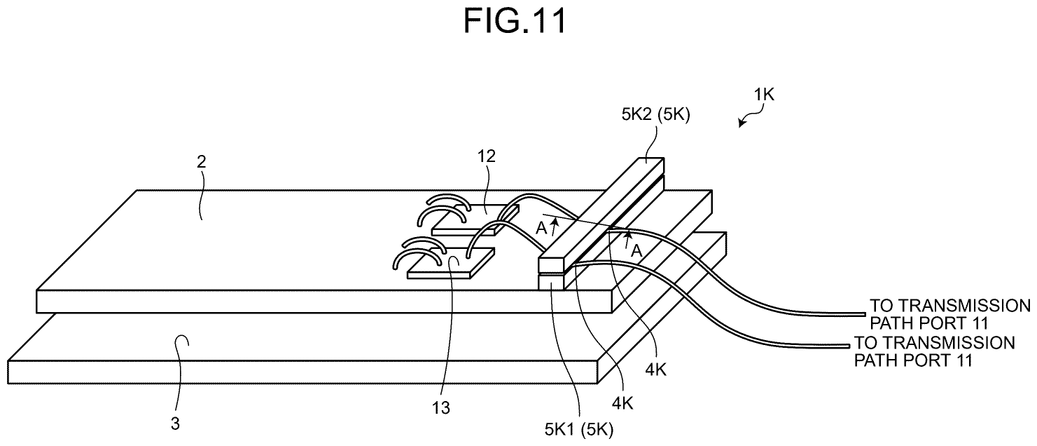

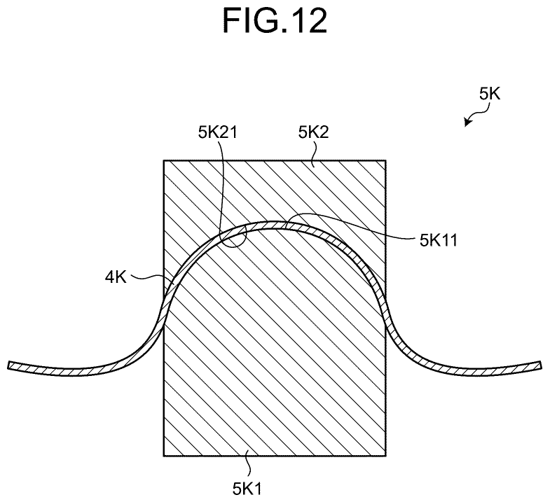

FIG. 11 is an explanation diagram illustrating one example of the optical module 1H according to the eleventh embodiment, and FIG. 12 is an explanation diagram illustrating one example of cross-sectional view taken along line A-A illustrated in FIG. 11. Furthermore, by assigning the same reference numerals to components having the same configuration as those in the optical module 1 according to the first embodiment, overlapped descriptions of the configuration and the operation thereof will be omitted. A holding mechanism 5K according to the eleventh embodiment is different from the holding mechanism 5 according to the first embodiment in that an optical fiber 4K is held by forming the bending shape having the predetermined radius of curvature by two curved surfaces that are arranged on the upper side and the lower side of the optical fiber 4K.

The holding mechanism 5K includes a first structure unit 5K1 that has a first curved surface 5K11 that holds the optical fiber 4K, and a second structure unit 5K2 that has a second curved surface 5K21 that holds the optical fiber 4K and that is disposed opposite the first curved surface 5K11. The holding mechanism 5K forms the shape of the optical fiber 4K having the predetermined radius of curvature by sandwiching the optical fiber 4K by the first curved surface 5K11 and the second curved surface 5K21, and holds the formed shape.

In an optical module 1K according to the eleventh embodiment, the shape of the optical fiber 4K having the predetermined radius of curvature is held by sandwiching the optical fiber 4K by the first curved surface 5K11 and the second curved surface 5K21. As a result of this, the bending shape of the optical fiber 4K is being held, so that it is possible to ensure the stable mode filter function and eliminate the mandrel that is conventionally used, and, consequently, it is possible to implement a reduction in the size of the module main body. In addition, the optical fiber 4K is held by the holding mechanism 5K, so that it is possible to suppress a rupture probability and an optical axis misalignment of the optical fiber 4K while suppressing the stress of the optical fiber 4K itself.

Moreover, regarding the optical module 1 according to the first embodiment, the case has been described as an example in which the holding mechanism 5 is mounted on the substrate 2, and an embodiment of one example thereof will be described below as a twelfth embodiment.
(1) Twelfth Embodiment

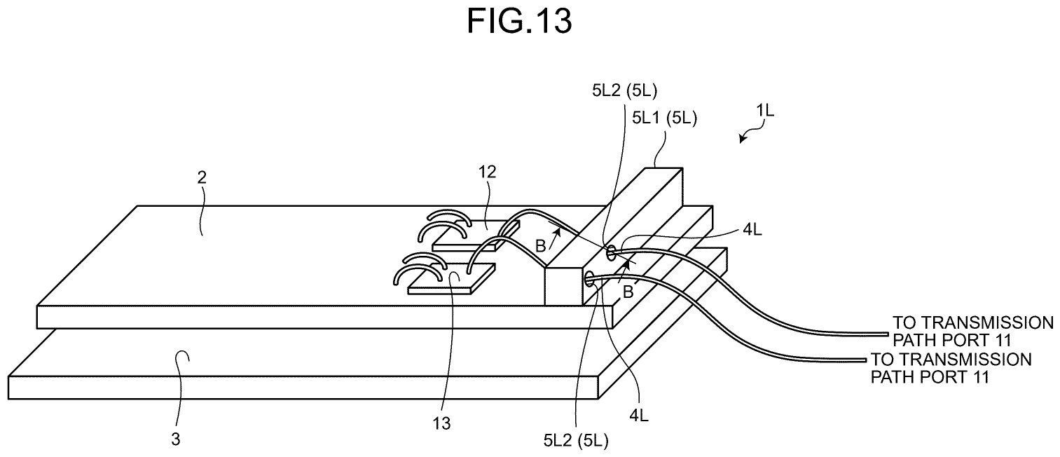

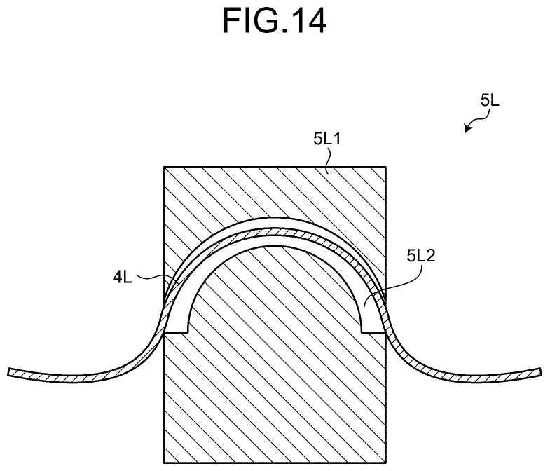

FIG. 13 is an explanation diagram illustrating one example of an optical module 1L according to the twelfth embodiment, and FIG. 14 is an explanation diagram illustrating one example of a cross-sectional view taken along line B-B illustrated in FIG. 13. Furthermore, by assigning the same reference numerals to components having the same configuration as those in the optical module 1 according to the first embodiment, overlapped descriptions of the configuration and the operation thereof will be omitted. A holding mechanism 5L according to the twelfth embodiment is different from the holding mechanism 5 according to the first embodiment in that the bending shape of the predetermined radius of curvature is formed by an inner circumferential surface 5L21 of an insertion hole 5L2 through which an optical fiber 4L is inserted.

The holding mechanism 5L includes a structure unit 5L1 provided with the insertion hole 5L2 that holds the optical fiber 4L in a state in which the optical fiber 4L is inserted. The holding mechanism 5L forms the shape of the optical fiber 4L having the predetermined radius of curvature by the inner circumferential surface 5L21 of the insertion hole 5L2 by allowing the optical fiber 4L to be inserted into the insertion hole 5L2, and holds the formed shape of the optical fiber 4L.

With the holding mechanism 5L included in the optical module 1L according to the twelfth embodiment, the optical fiber 4L is inserted into the insertion hole 5L2 included in the structure unit 5L1, and the optical fiber 4L is held by forming the shape of the optical fiber 4L having the predetermined radius of curvature by the inner circumferential surface 5L21 included in the insertion hole 5L2. As a result of this, the bending shape of the optical fiber 4L has been formed and held, so that it is possible to ensure the stable mode filter function and eliminate the mandrel that is conventionally used, and, consequently, it is possible to implement a reduction in the size of the module main body. In addition, the optical fiber 4L is held by the holding mechanism 5L, so that it is possible to suppress a rupture probability and an optical axis misalignment of the optical fiber 4L while suppressing the stress of the optical fiber 4L itself.

Moreover, regarding the optical module 1 according to the first embodiment, the case has been described as an example in which the holding mechanism 5 is mounted on the substrate 2, and an embodiment of one example thereof will be described below as a thirteenth embodiment.
(m) Thirteenth Embodiment

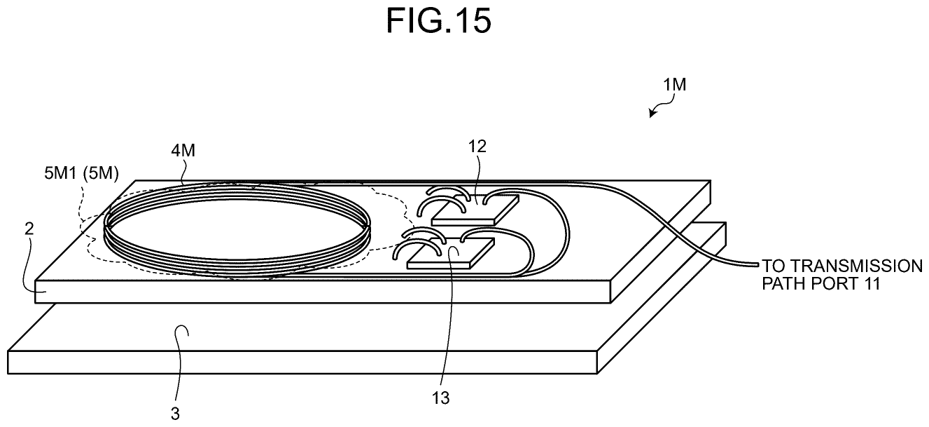

FIG. 15 is an explanation diagram illustrating one example of an optical module 1M according to the thirteenth embodiment. Furthermore, by assigning the same reference numerals to components having the same configuration as those in the optical module 1 according to the first embodiment, overlapped descriptions of the configuration and the operation thereof will be omitted. A holding mechanism 5M according to the thirteenth embodiment is different from the holding mechanism 5 according to the first embodiment in that the holding mechanism 5M forms the bending shape of an optical fiber 4M having a predetermined radius of curvature by using a material 5M1 whose state is changed from a softened state to a cured state, and holds the formed bending shape of the optical fiber 4M.

The holding mechanism 5M holds the shape of the optical fiber 4M having the predetermined radius of curvature by using the material 5M1 that is cured in a state in which the optical fiber 4M having the predetermined radius of curvature is inserted into the softened state of the material 5M1.

In the holding mechanism 5M included in the optical module 1M according to the thirteenth embodiment, the material 5M1 is cured in a state in which the optical fiber 4M having the predetermined radius of curvature is inserted into the softened state of the material 5M1, and the shape of the optical fiber 4M having the predetermined radius of curvature is held by the cured material 5M1. As a result of this, the bending shape of the optical fiber 4M is held, so that it is possible to ensure the stable mode filter function and eliminate the mandrel that is conventionally used, and, consequently, it is possible to implement a reduction in the size of the module main body. In addition, the optical fiber 4M is held by the holding mechanism 5M, so that it is possible to suppress a rupture probability and an optical axis misalignment of the optical fiber 4M while suppressing the stress of the optical fiber 4M itself.

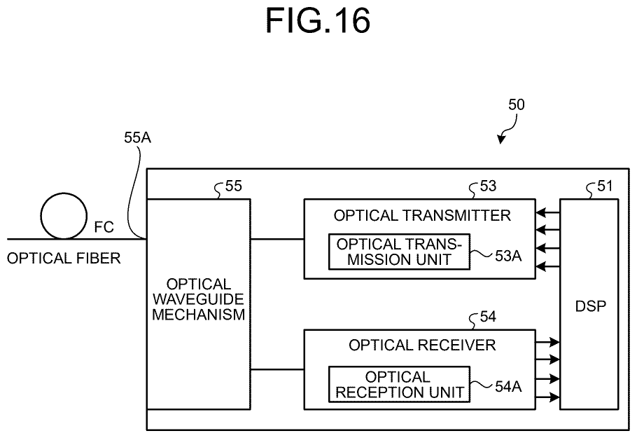

In the following, an optical transceiver 50 using the optical module according to the first to the thirteenth embodiments will be described. FIG. 16 is an explanation diagram illustrating one example of the optical transceiver 50 according to the present embodiment. The optical transceiver 50 illustrated in FIG. 16 is connected to an optical fiber FC that is disposed on a transmission path side. The optical transceiver 50 includes a digital signal processor (DSP) 51, an optical transmitter 53, an optical receiver 54, and an optical waveguide mechanism 55. The DSP 51 is an electrical component that performs digital signal processing. The DSP 51 performs a process of encoding, for example, transmission data or the like, generates an electrical signal including transmission data, and outputs the generated electrical signal to the optical transmitter 53. In addition, the DSP 51 acquires an electrical signal including reception data from the optical receiver 54, and obtains reception data by performing a process of decoding the acquired electrical signal.

The optical transmitter 53 modulates an optical signal by using the electrical signal that is output from the DSP 51, and outputs the obtained transmission light to the optical fiber having the predetermined radius of curvature included in the optical waveguide mechanism 55. The optical transmitter 53 includes an optical transmission unit 53A that generates transmission light by modulating, when the optical signal propagating through the optical fiber having the predetermined radius of curvature included in the optical waveguide mechanism 55, the electrical signal that is input to the optical signal.

The optical receiver 54 includes an optical reception unit 54A that receives reception light from the optical fiber having the predetermined radius of curvature included in the optical waveguide mechanism 55, and that demodulates the reception light by using light. Then, the optical receiver 54 converts the demodulated reception light to an electrical signal, and outputs the converted electrical signal to the DSP 51.

The optical waveguide mechanism 55 includes a transmission path port 55A that is connected to the optical fiber FC, the optical fiber that connects the transmission path port 55A to the optical transmitter 53 and the optical receiver 54 and that is formed in the bending shape having the predetermined radius of curvature, and a holding mechanism that holds the bending shape of the optical fiber. The holding mechanism holds the bending shape of the optical fiber that has the predetermined radius of curvature and through which only the basic mode included in the optical signal passing through the optical fiber propagates. In other words, the optical fiber that has the bending shape having the predetermined radius of curvature is an optical fiber having, for example, a mode filter function applied to the first to the thirteenth embodiments.

In the optical transceiver 50 according to the present embodiment, the holding mechanism that holds the bending shape of the optical fiber that has the predetermined radius of curvature and in which the mode filter function is able to be fulfilled is provided in the optical waveguide mechanism 55. As a result of this, in the holding mechanism, the bending shape having the predetermined radius of curvature is held, so that it is possible to ensure the stable mode filter function and eliminate the mandrel that is conventionally used, and, consequently, it is possible to implement a reduction in the size of the module main body. In addition, the optical fiber is held by the holding mechanism, so that it is possible to suppress a rupture probability and an optical axis misalignment of the optical fiber while suppressing the stress of the optical fiber itself.

Each of the components in the units illustrated in the drawings is not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

According to an aspect of an embodiment, it is possible to contribute to a reduction in the size of the module main body while ensuring a stable mode filter function.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical module comprising:
an optical transmitter that outputs transmission light to a transmission path port by using an optical signal;
an optical receiver that receives reception light received from the transmission path port by using the optical signal; and
an optical fiber that is a single mode optical fiber (SMF), that connects the optical transmitter and the optical receiver to the transmission path port, and through which the optical signal propagates, wherein
a wavelength of the optical signal is equal to or less than a cutoff wavelength of the optical fiber, wherein the optical module including:
a holding mechanism that holds a bending shape of the optical fiber that has a predetermined radius of curvature and through which only a basic mode included in the optical signal propagates.

2. The optical module according to claim 1, wherein the wavelength of the optical signal is equal to or less than 1.26 μm that is the cutoff wavelength of the SMF optical fiber in a wavelength range of 1.3 μm.

3. The optical module according to claim 1, wherein the holding mechanism is constituted by the optical fiber that has been preformed in the bending shape having the predetermined radius of curvature by using stress relaxation by heat, and holds the bending shape of the optical fiber having the predetermined radius of curvature.

4. The optical module according to claim 1, wherein the holding mechanism is arranged on a substrate on which the optical transmitter and the optical receiver are packaged or arranged on a housing on which the substrate is mounted, and holds the bending shape of the optical fiber having the predetermined radius of curvature.

5. The optical module according to claim 4, wherein the holding mechanism
includes
a first holder that is arranged on one end side of the substrate, and that holds one end of the optical fiber, and
a second holder that is arranged on the other end side of the substrate, and that holds the other end of the optical fiber, and
holds, by using the first holder and the second holder, the shape of the optical fiber having the predetermined radius of curvature.

6. The optical module according to claim 4, wherein the holding mechanism
includes
a first holder that is arranged on one end side of the housing, and that holds one end of the optical fiber, and
a second holder that is arranged on the other end side of the housing, and that holds the other end of the optical fiber, and
holds, by using the first holder and the second holder, the shape of the optical fiber having the predetermined radius of curvature.

7. The optical module according to claim 1, wherein the holding mechanism
includes
a first holder that includes two first columnar supports, and that holds one end of the optical fiber, and
a second holder that includes two second columnar supports, and that holds the other end of the optical fiber,
forms the shape of the optical fiber having the predetermined radius of curvature by holding an outer circumference and an inner circumference of the one end of the optical fiber in a state in which a part of the optical fiber is sandwiched between the two first columnar supports and by holding an outer circumference and an inner circumference of the other end of the optical fiber in a state in which a part of the optical fiber is sandwiched between the two second columnar supports, and
holds the formed shape of the optical fiber.

8. The optical module according to claim 1, wherein the holding mechanism
includes a holding groove that is provided on a top surface of a substrate on which the optical transmitter and the optical receiver are packaged, and that holds the optical fiber,
forms the shape of the optical fiber having the predetermined radius of curvature by holding the optical fiber in a state in which the optical fiber is routed in an interior of the holding groove, and
holds the formed shape of the optical fiber.

9. The optical module according to claim 1, wherein the holding mechanism
includes a holding groove that is provided on a top surface of a housing having mounted thereon a substrate on which the optical transmitter and the optical receiver are packaged, and that holds the optical fiber,
forms the shape of the optical fiber having the predetermined radius of curvature by holding the optical fiber in a state in which the optical fiber is routed in an interior of the holding groove, and
holds the formed shape of the optical fiber.

10. The optical module according to claim 1, wherein the holding mechanism
includes
a first structure body that includes a first plane that abuts the optical fiber from a plane direction of the optical fiber, and
a second structure body that includes a second plane that abuts the optical fiber from a plane direction of the optical fiber and that is disposed opposite the first plane, and
holds the shape of the optical fiber having the predetermined radius of curvature by sandwiching the optical fiber by the first plane and the second plane from the plane directions.

11. The optical module according to claim 1, wherein the holding mechanism
includes
a first structure body that includes a first curved surface that holds the optical fiber, and
a second structure body that includes a second curved surface that holds the optical fiber and that is disposed opposite the first curved surface,
forms the shape of the optical fiber having the predetermined radius of curvature by sandwiching the optical fiber by the first curved surface and the second curved surface, and
holds the formed shape of the optical fiber.

12. The optical module according to claim 1, wherein the holding mechanism
includes a structure body provided with an insertion hole that holds the optical fiber in a state in which the optical fiber is inserted,
forms the shape of the optical fiber having the predetermined radius of curvature by an inner circumferential surface of the insertion hole, and
holds the formed shape of the optical fiber.

13. The optical module according to claim 1, wherein the holding mechanism
uses a material whose state is to be changed from a softened state to a cured state, and
holds the shape of the optical fiber having the predetermined radius of curvature by the material that is cured in a state in which the optical fiber is inserted into the material that is in the softened state.

14. An optical transceiver comprising:
an optical transmitter that outputs transmission light to a transmission path port by using an electrical signal and an optical signal in accordance with transmission data;
an optical receiver that receives reception light received from the transmission path port by using the optical signal, and that obtains the electrical signal from the received reception light in accordance with reception data;
a processor that executes signal processing on the electrical signal; and
an optical waveguide mechanism that includes an optical fiber that is a single mode optical fiber (SMF), that connects the optical transmitter and the optical receiver to the transmission path port, and through which the optical signal propagates, wherein
a wavelength of the optical signal is equal to or less than a cutoff wavelength of the optical fiber, and
the optical waveguide mechanism includes a holding mechanism that holds a bending shape of the optical fiber having a predetermined radius of curvature and through which only a basic mode included in the optical signal propagates.
